(19) United States
(12) Patent Application Publication
(10) Pub. No.: US 2006/0087576 A1
(43) Pub. Date: Apr. 27, 2006

(54) Charge transfer device, and control method therefor

(76) Inventors: Shinichiro Izawa, Motosu-shi (JP); Masahiro Oda, Itami-shi (JP)

Correspondence Address: CANTOR COLBURN, LLP, 55 GRIFFIN ROAD SOUTH, BLOOMFIELD, CT, 06002, US

(21) Appl. No.: 11/251,253

(22) Filed: Oct. 14, 2005

(30) Foreign Application Priority Data
Oct. 22, 2004 (JP) JP2004-307617

(51) Int. Cl. H04N 5/335

(52) U.S. Cl. 348/302

(57) ABSTRACT

There is provided a charge transfer element, comprising a shift register, with a plurality of transfer electrodes, for transmitting information charge by application of clock pulses to the transfer electrodes, and an output section for outputting an output voltage according to information charge sequentially transferred and output from the shift register, a driver for applying clock pulses to the transfer electrodes at a specified timing, and a sampling circuit for sampling output voltage output from the output section, wherein the sampling circuit samples the output voltage, avoiding points in time where the clock pulses applied to the transfer electrodes change. In this way, it is possible to reduce noise that is superimposed on an output signal of a solid state imaging device.

### CROSS-REFERENCE TO RELATED APPLICATIONS

The entire disclosure of Japanese Patent Application No. 2004-307617, including specification, claims, drawings, and abstract, is incorporated herein by reference.

### BACKGROUND OF THE INVENTION

1. Field of the Invention

The present invention relates to a charge transfer device having reduced noise superimposed on an output signal, and to a control method therefor.

2. Description of the Related Art

FIG. 3 is a schematic diagram of a solid state imaging device containing CCD solid state imaging elements of a frame transfer type. The frame transfer type CCD solid state imaging element 2 is made up of an imaging section 2i, an accumulation section 2s, a horizontal transfer section 2h, and an output section 2d.

The imaging section 2i of the CCD solid state imaging element 2 is provided with a light receiving pixel that receives light from outside, and generates information charge of an amount corresponding to the strength of this incoming light. A vertical clock pulse is input to the imaging section 2i from a driver 100, and transfer of an image formed by the light receiving pixel, and information charge generated by the light receiving pixel, is carried out in response to change in the vertical clock pulse. Information charge is transferred at high speed to the accumulation section 2s by application of the vertical clock pulse. A vertical clock pulse and an output control clock are input from the driver 100 to the accumulation section 2s. In the accumulation section 2s, as a result of the application of the vertical clock pulse and the output control signal information charge is held and information charge is transferred one line at a time to the horizontal transfer section 2h. A horizontal clock pulse is input from the driver 100 to the horizontal transfer section 2h. At the horizontal transfer section 2h, the horizontal clock pulse is received and information charge is transferred to the output section 2d in one pixel units. The output section 2d converts information charge amount for each pixel to a voltage value, and variation in that voltage value is made CCD output.

The driver 100, including a timing generator, outputs control clock such as the vertical clock pulse and the horizontal clock pulse to each part of the CCD solid state imaging element 2. Also, the analog front-end circuit (AFE) 102 samples the outputs from the CCD solid state imaging element 2 and processes them as image signals.

FIG. 4 shows a cross section of part of the horizontal transfer section 2h and the output section 2d. The horizontal transfer section 2h includes a horizontal shift register for receiving and transferring information charge output from a vertical shift register of the accumulation section 2s. The horizontal shift register is configured with an N-well formed in a surface region of a semiconductor substrate 6 (or P-well) as a channel region 4, and has horizontal transfer electrodes 14-1 to 14-6 arranged on this channel region 4 via an insulation film. Respectively adjacent pairs of horizontal transfer electrodes 14-1, 14-2, 14-3, 14-4, and 14-5, 14-6 correspond to one pixel (bit), and the respective pairs are arranged in association with one vertical shift register.

Information charge is sequentially transferred across potential wells of the vertical shift register, and information charge for vertical shift registers of odd number rows and vertical shift registers of even number rows is written alternately to potential wells formed below electrodes 14-1 to 14-6 of the horizontal shift registers. After relocating charge by respectively independently controlling horizontal clock pulses applied to the transfer electrodes 14-1 to 14-6, potential wells of the horizontal shift register are sequentially transferred to the left by applying horizontal clock pulses φ_{H1}, φ_{H2} and φ_{H3} having three respectively different phases to the transfer electrodes 14-1, 14-4, the transfer electrodes 14-2, 14-5, and the transfer electrodes 14-3, 14-6, and information charge is transferred to a floating diffusion (FD) 18 by way of the underneath of an output gate (OG) 16, as shown in the timing chart of FIG. 5.

The floating diffusion 18 is an N+ diffusion layer. At time t₀, if a reset clock φ_{R} applied to a reset gate (RG) 22 adjacent to the floating diffusion is made ON, information charge that has been transferred to the floating diffusion 18 is discharged to a drain region 20. At time t₁, if the reset clock φ_{R} is returned to OFF, the potential of the floating diffusion 18 is set to voltage V_{ref}. The AFE 102 samples the voltage V_{ref} as a reference voltage in a period when a sampling signal S_{ref} is at a high level, that is, in a period a specified time T₁ after a predetermined standby time from this time t₁. After time t₂, if information charge is transferred from the horizontal shift register to the floating diffusion 18, the potential of the floating diffusion 18 is changed in accordance with this charge amount. The AFE 102 samples the potential of the floating diffusion 18 as an output voltage in a period where the sampling signal Sₒᵤₜ is at a high level, namely in a period a specified time T₂ from time t₃. A difference between the reference voltage and the output voltage becomes a voltage value representing an image signal.

However, with the above described CCD solid state imaging element of the related art, as shown in FIG. 5, in the period of time T₂ for sampling the potential of the floating diffusion 18 by the AFE 102, since the horizontal clock pulses φ_{H1} and φ_{H3} vary, there is a problem that noise is superimposed on the potential of the floating diffusion 18 at the time when horizontal clock pulses φ_{H1} and φ_{H3} are varied. As a result, a problem arises where the potential value representing the image signal is also subjected to the effects of noise, and image quality of a taken image is degraded.

### SUMMARY OF THE INVENTION

The present invention comprises a charge transfer element, provided with a shift register, with a plurality of transfer electrodes, for transmitting information charge by application of clock pulses to the transfer electrodes, and an output section for outputting an output voltage according to information charge sequentially transferred and output from the shift register, a driver for applying clock pulses to the transfer electrodes at a specified timing, and a sampling circuit for sampling output voltage output from the output section, wherein the sampling circuit samples the output voltage, avoiding a point in time where the clock pulses applied to the transfer electrodes vary.

### BRIEF DESCRIPTION OF THE DRAWINGS

Preferred embodiments of the present invention will be described in detail based on the following drawings, wherein:

FIG. 1 is a drawing showing the structure of a solid state imaging device of an embodiment of the present invention;

FIG. 2 is a timing chart for control of the solid state imaging element of the embodiment of the present invention.

FIG. 3 is a drawing showing the structure of a solid state imaging device of the related art.

FIG. 4 is a cross sectional drawing showing the structure of a horizontal transfer section and an output section of the CCD solid state imaging element of the related art.

FIG. 5 is a timing chart for control of the solid state imaging element of the related art.

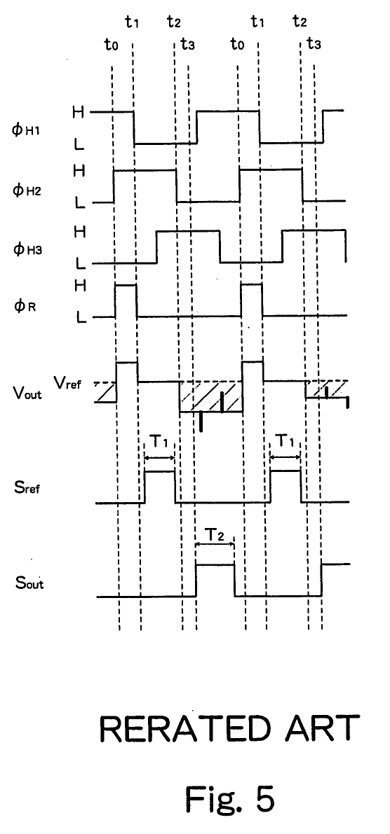

### DESCRIPTION OF THE PREFERRED EMBODIMENTS

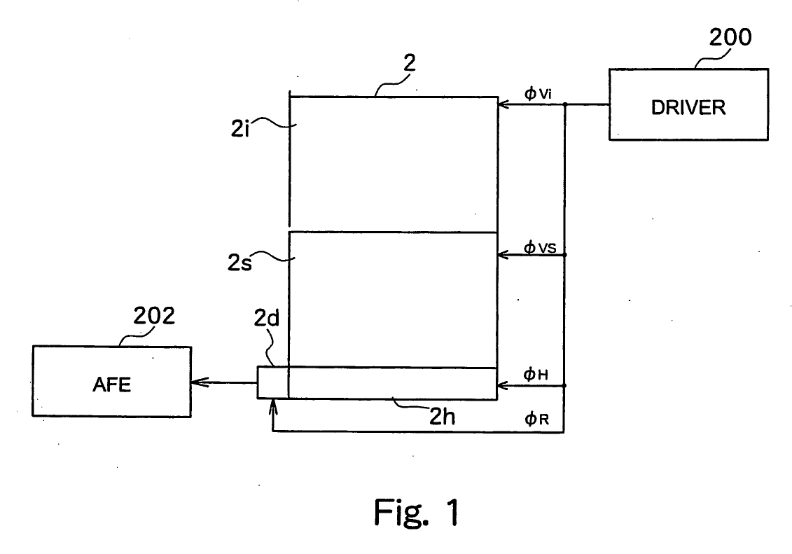

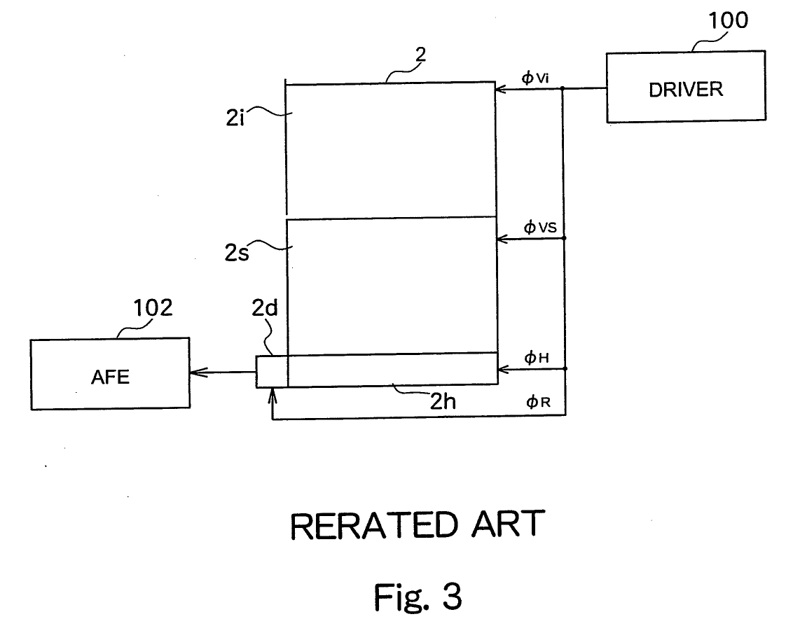

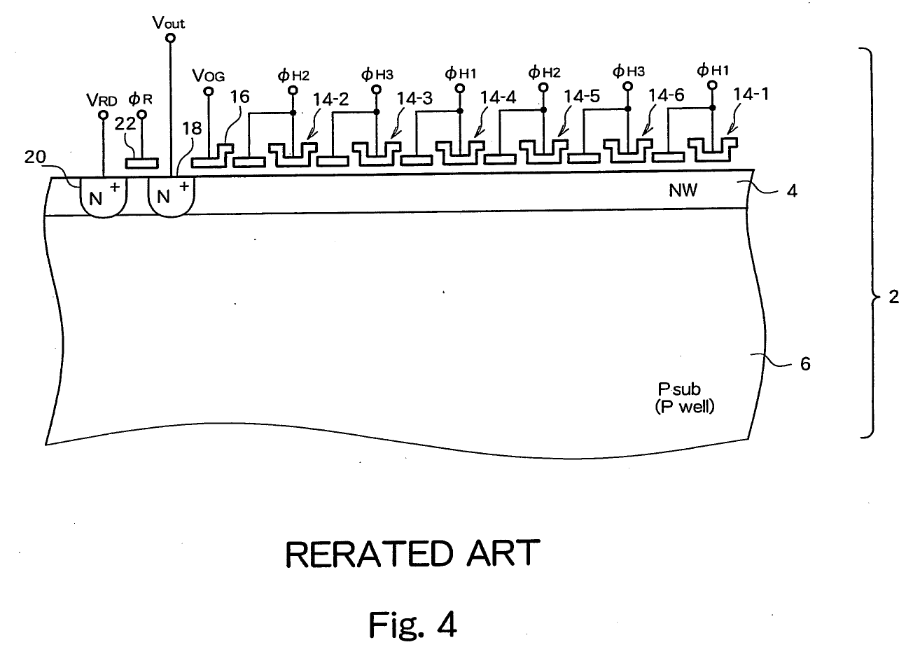

The solid state imaging element of the embodiment of the present invention, and a control method for this imaging element, will now be described with reference to the drawings. A shown in FIG. 1, the solid state imaging device of this embodiment comprises a CCD solid state imaging element 2, a driver 200 and an analog front end circuit (AFE) 202. The CCD solid state imaging element 2 of this embodiment has the same structure as the CCD solid state imaging element 2 of the related art shown in FIG. 3 and FIG. 4, and so description is omitted here.

The driver 200 including a timing generator outputs control clocks, such as vertical clock pulses, horizontal clock pulses and a reset clock to each part of the CCD solid state imaging element. The AFE 202 samples the output from the CCD solid-state imaging element 2, and subjects it to processing. This embodiment is characterized by the fact that horizontal transfer and sampling of the information charge is performed by the driver 200 and the AFE 202.

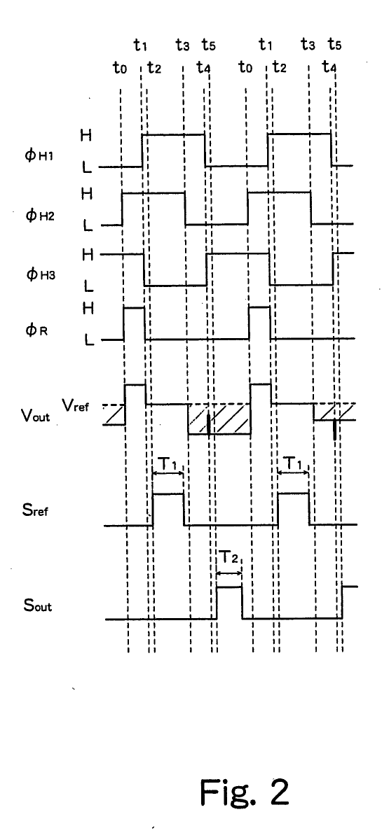

The control method for the solid state imaging element of this embodiment is carried out as shown in the timing chart of FIG. 2.

Information charge is sequentially transferred by potential wells of the vertical shift register, and information charge for odd-number vertical shift registers and even-number vertical shift registers is alternately read into potential wells formed below the electrodes 14-1 to 14-6 of the horizontal shift register. Then, after relocating information charge by independently controlling horizontal clock pulses applied to the transfer electrodes 14-1 to 14-6, as shown in the timing chart of FIG. 2 the potential wells of the horizontal register are sequentially transferred to the left by application of three differently phased horizontal clock pulses φ_{H1}, p_{H2} and φ_{H3} to the transfer electrodes 14-1, 14-4, the transfer electrodes 14-2, 14-5, and the transfer electrodes 14-3, 14-6, and the information charge is transferred to the floating diffusion (FD) 18 via the underneath of the output gate (OG) 16.

With this embodiment, the horizontal clock pulses φ_{H1} and φ_{H3} are applied in opposite phases, and sampling is carried out by the AFE 202 avoiding points in time where these clock pulses change.

At a time before time to, the horizontal clocks φ_{H1} and φ_{H2} are at low level, while φ_{H3} is at high level, and information charge that has been transferred from the horizontal transfer section 2h is being stored in the to the floating diffusion 18.

At time to, the horizontal clock pulse φ_{H2} is returned to a high level, and the reset clock φ_{R} applied to the reset gate (G) is turned on. A drain region 20 is maintained at a positive potential, and information charge that has been stored in the floating diffusion 18 is discharged to the drain region 20.

At time t₁, the horizontal clock pulse φ_{H1} is made high level, φ_{H3} is made low level, and the reset clock φ_{R} returns to being OFF. Information charge that has been stored in the floating diffusion 18 has been discharged to the drain region 20, and so the potential of the floating diffusion 18 becomes the potential V_{ref} when the floating diffusion 18 is emptied. The AFE 202 starts sampling in a period when the sampling signal S_{ref} is high level, that is, from a time t₂ after the lapse of a specified standby period from time t₁, and the potential of the floating diffusion is sampled as the reference voltage V_{ref} only for a specified period T₁.

After completion of sampling in the AFE 202, the horizontal clock pulse φ_{H2} is made low level at time t₃ a short standby period from the point in time where sampling is completed. In this way, information charge is sent from the potential wells of the horizontal shift register of the horizontal transfer section 2h, through the underneath of the output gate (OG) 16 to the floating diffusion 18. In accordance with sending of the information charge, the potential of the floating diffusion 18 is changed to a potential corresponding to the information charge amount.

After that, at time t₄, the horizontal clock pulse φ_{H1} is made low level, and the φ_{H3} is made high level. At this time, the horizontal clock pulse φ_{H2} is maintained at a low level, and the potential of the floating diffusion 18 is also held at the potential it was at a time t₃.

The AFE 202 starts sampling in a period when the sampling signal Sₒᵤₜ is high level, that is, from a time t₅ after the lapse of a specified standby period from time t₄, and the potential of the floating diffusion is sampled as the output voltage Vₒᵤₜ only for a specified period T₂. At the AFE 202, a difference between the output voltage sampled in the specified period T₂ and the reference voltage V_{ref} is processed as an image signal.

At this time, the specified period T₂ is preferable set from a point in time after a time where the horizontal clock pulses φ_{H1} and φ_{H3} have changed at time t₄, to a point in time before the next change of the horizontal clock pulses φ_{H1} , φ_{H2} ² and φ_{H3}3. Specifically, sampling of the potential of the floating diffusion 18 is preferably carried out by the AFE 202 avoiding times when the horizontal clock pulses φ_{H1}, φ_{H2} and φ_{H3} change.

After that, the control of times t₀- t₅ is repeated, and it is possible to sequentially output an image signal corresponding to the information charge that has been horizontally transferred, one pixel at a time.

Also with this embodiment, the horizontal clock pulses φ_{H1} and φ_{H3} are clock pulses in completely opposite phases, but it is not necessary for the points of change of the horizontal clock pulses φ_{H1} and φ_{H3} to be completely aligned, and it is also possible to set them almost aligned, and to carry out sampling avoiding the points in time where the horizontal clock pulses φ_{H1} and φ_{H3} change.

As has been described above, by carrying out control so that the horizontal clock pulses φ_{H1} and φ_{H3} are changed at almost the same time, and having none of the horizontal clock pulses φ_{H1}, φ_{H2} and φ_{H3} change in the period T₂ when the potential of the floating diffusion 18 is sampled, it is possible to avoid noise being superimposed on a sampling value of the floating diffusion 18 due to the influence of change in the horizontal clock pulses φ_{H1} and φ_{H3}. As a result, it is possible to avoid the effects of noise being superimposed on the image signal, and it is possible to prevent degradation of image quality of the taken image.

With this embodiment, description has been given of an example of controlling a solid state imaging element using three phase horizontal clock pulses φ_{H1}, φ_{H2} and φ_{H3}, but this is not limiting, and even in the case of using horizontal clock pulses of more phases, it is possible to achieve the same operation and effects by not changing the horizontal clock pulses at the same phase as each other, making the points where the horizontal clock pulses change close together, and carrying out sampling while avoiding those points in time where the horizontal clock pulses change.

However, accompanying increase in the number of phases of the horizontal clock pulses, there is an increase in the points of variation in the horizontal clock pulses, which means that it becomes difficult to make the points of change in the horizontal clock pulses close together. Therefore, the present invention is preferably adopted in horizontal transfer that uses three phases of horizontal clock pulses φ_{H1}, φ_{H2} and φ_{H3}.

What is claimed is:

1. A charge transfer device, comprising:
a charge transfer element, provided with
a shift register, with a plurality of transfer electrodes, for transmitting information charge by application of clock pulses to the transfer electrodes; and
an output section for outputting an output voltage according to information charge sequentially transferred and output from the shift register;
a driver for applying clock pulses to the transfer electrodes at a specified timing; and
a sampling circuit for sampling output voltage output from the output section,
wherein the sampling circuit samples the output voltage, avoiding a point in time where the clock pulses applied to the transfer electrodes vary.

2. The charge transfer device of claim 1, wherein
the driver generates clock pulses of a number of different phases, and the clock pulses of different phases are respectively applied to each of the plurality transfer electrodes.

3. The charge transfer device of claim 2, wherein
the driver generates three clock pulses of different phases, and among these three phases, clock pulses of two phases that change in substantially opposite phases are respectively applied to each of the plurality transfer electrodes.

4. A control method, for a charge transfer device, for controlling a charge transfer element, provided with a shift register, having a plurality of transfer electrodes, for transmitting information charge by application of clock pulses to the transfer electrodes, and an output section for outputting an output voltage according to information charge sequentially transferred and output from the shift register, wherein
clock pulses are applied to the transfer electrodes at a specified timing; and
the output voltage is sampled avoiding a point in time where the clock pulses applied to the transfer electrodes vary.
